(19) United States
(12) Patent Application Publication
(10) Pub. No.: US 2011/0167187 A1
(43) Pub. Date: Jul. 7, 2011

(54) CONNECTORS IN A PORTABLE DEVICE

(75) Inventors: Alex Crumlin, San Jose, CA (US); Paul M. Thompson, San Jose, CA (US)

(73) Assignee: Apple Inc., Cupertino, CA (US)

(21) Appl. No.: 12/695,114

(22) Filed: Jan. 27, 2010

Related U.S. Application Data
(60) Provisional application No. 61/292,788, filed on Jan. 6, 2010.

(51) Int. Cl. G06F 13/00; H02J 7/00; G06F 21/00

(52) U.S. Cl. 710/303; 320/137; 726/16

(57) ABSTRACT

Circuits, methods, and apparatus that allow a portable electronic device to be placed in a second electronic device in more than one orientation. One example allows a portable computing device to be placed in a docking station in both landscape and portrait orientations. In this example, this is achieved by including two connector receptacles, one on each of at least two sides of the portable computing device.

### CROSS-REFERENCES TO RELATED APPLICATIONS

This application claims the benefit of U.S. provisional patent application No. 61/292,788, filed Jan. 6, 2010, which is incorporated by reference.

### BACKGROUND

The popularity of various portable electronic devices has exploded the past several years and the public's fascination and desire for new devices shows no signs of abating. Along with this increase in popularity, the number of types of these portable devices has grown considerably, and the functionality of these devices has diversified tremendously.

Interestingly, this diversification has become so thorough that it has begun to lead to convergence. One such convergence is occurring with portable computing devices.

Smaller devices, such as phones, can now be used to perform functions that were previously limited to larger computing devices. These go beyond native functions, such as actually calling people, and include listening to music, watching movies, viewing documents, surfing the web, and reading email. Larger devices, such as netbooks, are slimming down to ultraportable size by jettisoning their optical drives and other functionality.

The evolution of these devices is thus converging towards a common destination: the portable computing device. These devices may handle various functions currently assigned to phones and netbooks. They may be used to listen to music, watch movies, view and edit documents, surf the web, read email and books, as well as myriad other functions.

Users of these portable computing devices often hold them in their hands or laps when using them. In many cases though, it is desirable to place them in a docking station or similar device. These devices may provide mechanical support for the portable computing device, holding them in place in a roughly upright manner so that the screen can be viewed easily. As well as providing mechanical support, docking stations may include connectors that can connect to other computers, speakers, monitors, or other electronic apparatus.

For some applications running on a portable computing device, it is desirable that a docking station hold a portable computing device with a landscape orientation. This is useful for watching movies, as an example. For other applications, such as reading a book, a portrait orientation is useful. Accordingly, what is needed are circuits, methods, and apparatus that allow connection to a docking station or other devices in both landscape and portrait orientations.

### SUMMARY

Accordingly, embodiments of the present invention provide circuits, methods, and apparatus that allow a portable electronic device to be placed in a second electronic device in more than one orientation. An illustrative embodiment of the present invention allows a portable computing device to be placed in a docking station in both landscape and portrait orientations. In this illustrative embodiment of the present invention, this is achieved by including two connector receptacles, one on each of at least two sides of the portable computing device.

While embodiments of the present invention are particularly suited for implementation in portable computing devices, other devices, such as phones or monitors, can be improved by the incorporation of embodiments of the present invention. Also, while connector receptacles are used in various examples, other embodiments of the present invention employ one or more other types of connections, such as connector plugs, in place of one or more of the connector receptacles. Other embodiments of the present invention may include connections on more than two sides of a portable device. For example, connections may be included on three or four sides of a device. Other connectors may be included on the front or back of a device as well. These connectors may also be used to position a portable computing or other device in other orientations besides portrait or landscape. These connectors may be used to position a portable computing or other device in a docking station or other type of device. In various embodiments of the present invention, the connectors may be used to make connections to other devices, such as portable media players, computers, or monitors, as well as docking stations.

In various embodiments of the present invention, the connectors may have pins or contacts that may receive or provide various types of power and data signals. In one illustrative embodiment of the present invention, one or more of the connectors may have pins for supplying or receiving power. Other pins for receiving or supplying universal serial bus (USB) signals, analog and digital video, analog and digital audio, serial data, and other types of data may also be included in one or more connectors in various embodiments of the present invention.

Power may be supplied by contacts or pins in one or more connectors in various embodiments of the present invention. These pins may include one or more positive power supply pins and grounds. In other embodiments of the present invention, they may include one or more negative power supplies and grounds, or positive power supplies and negative power supplies, or any other combination of positive power supply pins, negative power supply pins, and ground pins. In this embodiment, power pins in more than one connector may be used to provide power to one or more external devices. This power may be regulated. The power may be supplied or drawn at one or more different current levels. For example, registers may store values of maximum currents that may be drawn or supplied at any particular pin or supply. In one illustrative embodiment of the present invention, the regulator may be bypassed and the power pins connected to a battery through a non-regulated path in order to provide higher currents. In various embodiments of the present invention, power may be supplied at the same or different current levels by one or more connectors. In various embodiments of the present invention, power may be supplied by only one connector, or fewer than all connectors. In these embodiments, when more than one external device is connected, power may be supplied to the first external device connected, to the most recent device connected, or a prompt may appear on a screen of the device asking a user to indicate which external device should receive power.

Power may be received by one or more connectors in embodiments of the present invention. Received power may be used to power circuitry located in the portable computing or other device, to charge a battery associated with the portable computing or other device, or both. In various embodiments of the present invention, the magnitude of current that may be provided by an external power source can be determined by measuring voltage levels or other parameters at one or more pins. In a specific embodiment of the present invention, an available power level can be determined by measuring voltages at USB data pins. In various embodiments of the present invention, characteristics such as an available power level may be determined by reading a resistor value between two or more pins of a connector. Power received at these connectors may be converted to currents which can be combined to supply power or to charge a battery. In various embodiments of the present invention, power may be supplied at one or more connectors and received at one or more connectors.

Data signals, such as USB signals, may also be received and provided by pins of one or more connectors. These USB signals may be compliant with USB1, USB2, USB3, or other USB standards that have been developed, are currently being developed, or will be developed in the future. In a specific embodiment of the present invention, the electronic device can communicate with one, two, or more devices using the USB signal pins. In other embodiments of the present invention, two or more external electronic devices can communicate with each other through the electronic device. In yet other embodiments of the present invention, two or more external electronic devices can communicate with each other and with the electronic device. In other embodiments of the present invention, the electronic device can communicate with only one external device. In these embodiments, when more than one external device is connected, USB communications may be made with the first external device connected, the most recent external device connected, or a prompt may appear on a screen of the device asking a user to indicate which external device should be communicated with.

Video signals, analog, digital, or both, may be received and provided by pins of one or more connectors. Analog video signals may be compliant with one or more other video standards, such as one or more of the family of VGA standards. Digital video signals may be compliant with one or more standards such as DVI, HDMI, or DisplayPort. Various embodiments of the present invention may supply or receive analog, digital, or both analog and digital video signals that are compliant with standards that have been developed, are currently being developed, or will be developed in the future. In various embodiments of the present invention, video signals may be provided to one or more external devices. In various embodiments of the present invention, video signals may be received from one or more external devices. In other embodiments of the present invention, video signals may be sent from one external device to another external device through the electronic device. In yet other embodiments of the present invention, video signals may be sent from one external device to the electronic device and the external device. In other embodiments of the present invention, the electronic device can communicate with only one external device. In these embodiments, when more than one external device is connected, video signals may be received from or provided to the first external device connected, the most recent external device connected, or a prompt may appear on a screen of the device asking a user to indicate which external device video signals should be received from or provided to.

Audio signals, analog, digital, or both, may be received and provided by pins of one or more connectors. Analog audio signals may be compliant with one or more audio standards. Digital audio signals may be compliant with one or more standards such as MP3, WMA, WAV, or MIDI. Various embodiments of the present invention may supply or receive analog, digital, or both analog and digital audio signals that are compliant with standards that have been developed, are currently being developed, or will be developed in the future. In various embodiments of the present invention, audio signals may be provided to one or more external devices. In various embodiments of the present invention, audio signals may be received from one or more external devices. In other embodiments of the present invention, audio signals may be sent from one external device to another external device through the electronic device. In yet other embodiments of the present invention, audio signals may be sent from one external device to the electronic device and the external device. In other embodiments of the present invention, the electronic device can communicate with only one external device. In these embodiments, when more than one external device is connected, audio signals may be received from or provided to the first external device connected, the most recent external device connected, or a prompt may appear on a screen of the device asking a user to indicate which external device audio signals should be received from or provided to. In order to improve signal quality, an internal ground return line may be connected to whichever connector is providing audio signals.

Other data signals, such as serial data signals, may also be received and provided by pins of one or more connectors. These serial signals may be compliant with standards that have been developed, are currently being developed, or will be developed in the future. In a specific embodiment of the present invention, the electronic device can communicate with one, two, or more devices using the serial data pins. In other embodiments of the present invention, two or more external electronic devices can communicate with each other through the electronic device. In yet other embodiments of the present invention, two or more external electronic devices can communicate with each other and with the electronic device. In other embodiments of the present invention, the electronic device can communicate with only one external device. In these embodiments, when more than one external device is connected, serial data communications may be made with the first external device connected, the most recent external device connected, or a prompt may appear on a screen of the device asking a user to indicate which external device should be communicated with.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates an electronic system that may be improved by the incorporation of embodiments of the present invention;

FIG. 2 is a simplified block diagram of a system including a portable computing device and an accessory according to an embodiment of the present invention;

FIG. 3 illustrates an electronic system according to an embodiment of the present invention;

FIG. 4 is a flowchart illustrating the power supply and receiving capabilities of a connector of a portable computing device according to an embodiment of the present invention;

FIG. 5 is a flowchart illustrating a method of receiving power at multiple connectors of a portable computing device according to an embodiment of the present invention;

FIG. 6 illustrates an electronic system according to an embodiment of the present invention;

FIG. 7 illustrates a method of resolving a conflict over shared USB circuitry at multiple connectors of a portable computing device according to an embodiment of the present invention;

FIG. 8 illustrates a method of resolving conflicts at multiple connectors of a portable computing device when one or more connections are removed;

FIG. 9 illustrates an electronic system according to an embodiment of the present invention;

FIG. 10 illustrates a method of resolving a conflict for video circuitry shared between multiple connectors of a portable computing device according to an embodiment of the present invention;

FIG. 11 illustrates a method of resolving a conflict at multiple connectors when a connection at one of the connectors is broken;

FIG. 12 illustrates an electronic system according to an embodiment of the present invention;

FIG. 13 illustrates a method of resolving a conflict for audio circuitry shared between multiple connectors of a portable computing device according to an embodiment of the present invention;

FIG. 14 illustrates a method of resolving a conflict at multiple connectors when a connection at one of the connectors is broken; and

FIG. 15 illustrates an electronic system according to an embodiment of the present invention.

### DESCRIPTION OF ILLUSTRATIVE EMBODIMENTS

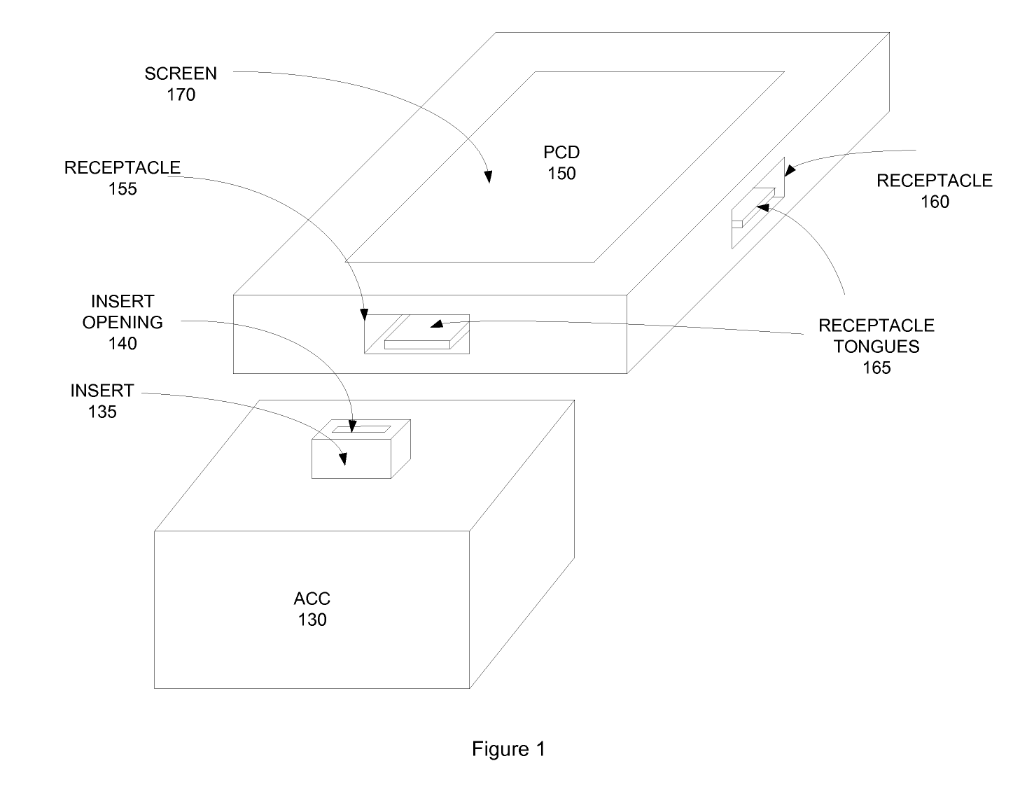

FIG. 1 illustrates an electronic system that may be improved by the incorporation of embodiments of the present invention. This figure includes portable computing device 150 and accessory 130. In this example, accessory 130 is a docking station, though in other examples, accessory 130 may be other types of devices, such as radios, monitors, interactive displays, and others. In this example, portable computing device 150 is a tablet computer, though in other systems it may be other types of devices, such as a portable media player, cell phone, monitor, or other electronic device.

Accessory 130 may include insert 135 having insert opening 140. Portable computing device 150 may have one or more receptacles 155 and 160. These receptacles 155 and 160 may include receptacle tongues 165. When portable computing device 150 is mated with accessory 130, insert 135 may fit in either receptacle 155 or 160. The corresponding receptacle tongue 165 may fit into insert opening 140. Contacts (not shown) on receptacle tongue 165 may form electrical connections with contacts in insert opening 140. These electrical connections may form pathways for power and signals that may be shared between accessory 130 and portable computing device 150.

Accessory 130 and portable computing device 150 may include various electronic circuitry for managing and sharing power and data signals. Examples of these circuits are shown in the following figure.

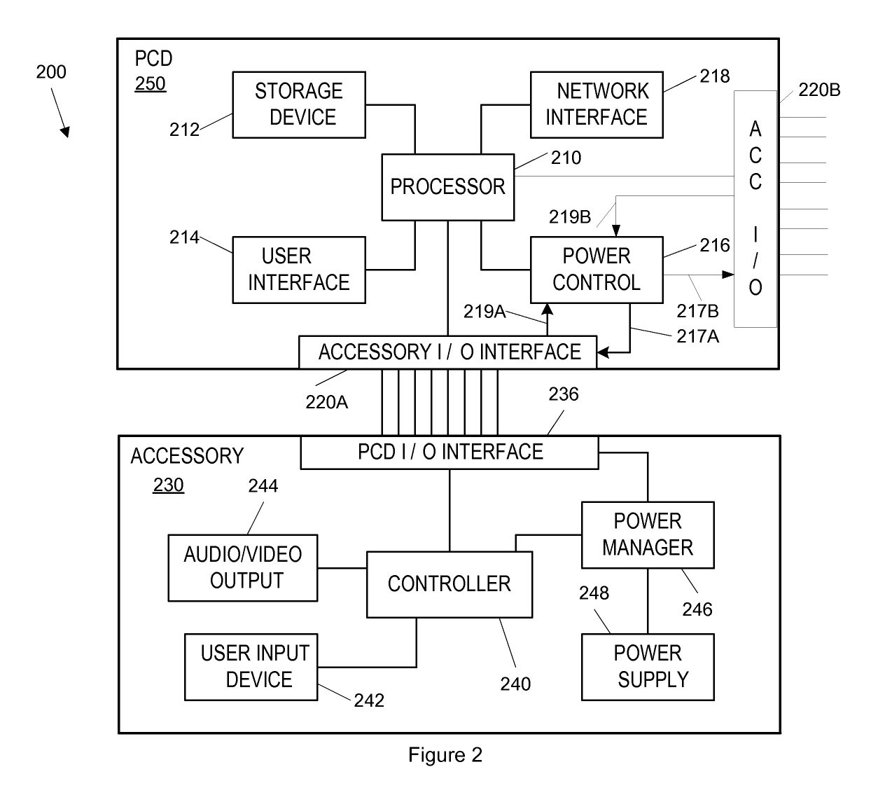

FIG. 2 is a simplified block diagram of a system 200 including portable computing device 250 and accessory 230 according to an embodiment of the present invention. This figure, as with the other included figures, is shown for illustrative purposes only, and does not limit either the possible embodiments of the present invention or the claims.

In this embodiment, portable computing device 250 (e.g., implementing portable computing device 150 of FIG. 1) can provide computing, communication and/or media playback capability. Portable computing device 250 can include processor 210, storage device 212, user interface 214, power manager 216, network interface 218, and accessory input/output (I/O) interfaces 220A and 220B. Portable computing device 250 can also include other components (not explicitly shown) to provide various enhanced capabilities.

Storage device 212 can be implemented using disk, flash memory, or any other non-volatile storage medium. In some embodiments, storage device 212 can store media assets such as audio, video, still images, or the like, that can be played by portable computing device 250. Storage device 212 can also store other information such as a user's contacts (names, addresses, phone numbers, etc.); scheduled appointments and events; notes; and/or other personal information. In some embodiments, storage device 212 can store one or more application programs to be executed by processor 210 (e.g., video game programs, personal information management programs, media playback programs, etc.).

User interface 214 can include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital-to-analog or analog-to-digital converters, signal processors, or the like). A user can operate input devices of user interface 214 to invoke the functionality of portable computing device 250 and can view and/or hear output from portable computing device 250 via output devices of user interface 214.

Processor 210, which can be implemented as one or more integrated circuits (e.g., a conventional microprocessor or microcontroller), can control the operation of portable computing device 250. In various embodiments of the present invention, processor 210 can execute a variety of programs in response to program code and can maintain multiple concurrently executing programs or processes. At any given time, some or all of the program code to be executed can be resident in processor 210 and/or in storage media such as storage device 212.

Through suitable programming, processor 210 can provide various functionality for portable computing device 250. For example, in response to user input signals provided by user interface 214, processor 210 can operate a database engine to navigate a database of media assets stored in storage device 212 in response to user input and display lists of selected assets. Processor 210 can respond to user selection of an asset (or assets) to be played by transferring asset information to a playback engine also operated by processor 210, thus allowing media content to be played. Processor 210 can also operate other programs to control other functions of portable computing device 250. In some embodiments, processor 210 implements a protocol daemon and other programs to manage communication with one or more connected accessories (e.g., accessory 230), examples of which are described below.

Power manager 216 provides power management capability for portable computing device 250. For example, power manager 216 can deliver power from a battery (not explicitly shown) to accessory I/O interfaces 220A and 220B via lines 217A and 217B and to other components of portable computing device 250 (power connections not shown). Power manager 216 can also receive power via accessory I/O interfaces 220A and 220B and lines 219A and 219B and deliver received power to various components of portable computing device 250. Power received from accessory 230 can also be delivered to the battery, thereby allowing the battery to be recharged via accessory I/O interface 220. In some embodiments, power manager 216 can be implemented using programmable or controllable circuits operating in response to control signals generated by program code executing on processor 210 or as a separate microprocessor or microcontroller.

In some embodiments, power manager 216 is responsive to signals from a sensor (not explicitly shown) in accessory I/O interface 220. The sensor can generate a signal indicative of the type of accessory connected, and power manager 216 can use this information to determine, e.g., whether to distribute power from the battery or power received from accessory I/O interface 220. Power manager 216 can also provide other power management capabilities, such as regulating power consumption of other components of portable computing device 250 based on the source and amount of available power, monitoring stored power in the battery and generating user alerts if the stored power drops below a minimum level, and so on.

Network interface 218 can provide voice and/or data communication capability for portable computing device 250. In some embodiments of the present invention, network interface 218 can include radio frequency (RF) transceiver components for accessing wireless voice and/or data networks (e.g., using cellular telephone technology, advanced data network technology such as 3G or EDGE, WiFi (IEEE 802.11 family standards), or other mobile communication technologies, or any combination thereof), GPS receiver components, and/or other components. In some embodiments network interface 218 can provide wired network connectivity (e.g., Ethernet) in addition to or instead of a wireless interface. Network interface 218 can be implemented using a combination of hardware (e.g., antennas, modulators/demodulators, encoders/decoders, and other analog and/or digital signal processing circuits) and software components.

Accessory I/O interfaces 220A and 220B can allow portable computing device 250 to communicate with various accessories. For example, accessory I/O interfaces 220A and 220B can support connections to a computer, an external speaker dock or media playback station, a digital camera, a radio tuner (e.g., FM, AM and/or satellite), an in-vehicle entertainment system, an external video device, card reader, disc reader, or the like. In accordance with some embodiments of the invention, accessory I/O interface 220 can support connection to multiple accessories in a daisy chain configuration, allowing portable computing device 250 to manage concurrent communication with multiple accessories. This can be done, for example, by associating multiple virtual ports with a physical communication port provided by accessory I/O interfaces 220A and 220B.

In some embodiments, accessory I/O interfaces 220A and 220B can include a connector, such as a 30-pin connector corresponding to the connector used on iPod® and iPhone® products, as well as supporting circuitry. The connector can provide connections for power and ground as well as for various wired communication interfaces such as Universal Serial Bus (USB), FireWire (IEEE 1394 standard), and/or universal asynchronous receiver/transmitter (UART). The connector can also provide connections for audio and/or video signals, which may be transmitted to or from portable computing device 250 in analog and/or digital formats. Thus, accessory I/O interfaces 220A and 220B can support multiple communication channels, and a given accessory can use any or all of these channels.

Accessory 230 can include controller 240, user input device 242, audio/video output device 244, power manager 246, power supply 248 and PCD I/O interface 236. Accessories can vary widely in capability, complexity, and form factor. Various accessories may include components that are not shown, which may include, but are not limited to, storage devices (disk, flash memory, etc.) with fixed or removable storage media; camera components such as lenses, image sensors, and controls for same (e.g., aperture, zoom, exposure time, frame rate, etc.); microphones for recording audio (either alone or in connection with video recording); and so on.

Controller 240 can include a microprocessor or microcontroller executing program code to perform various operations associated with accessory 230. For example, where accessory 230 incorporates a sound and/or video system, program code executed by controller 240 can include programs for digital audio decoding, analog or digital audio processing, and the like. Where accessory 230 incorporates a digital camera, program code executed by controller 240 can include programs that allow a user to control the camera to adjust settings, capture images, display images, transfer image data to another electronic apparatus, etc.

User input device 242 may include user-operable controls such as a touch pad, touch screen, scroll wheel, click wheel, dial, button, switch, keyboard, keypad, microphone, or the like. A user can operate the various input controls of user interface 234 to invoke functionality of accessory 230, and such functionality may include exchanging control signals, data, or other communications with portable computing device 150, either directly or via an intermediary.

In some embodiments, accessory 230 can also provide output devices such as audio/video output device 244. In some embodiments, audio/video output device 244 can include speakers and/or connection ports for connecting external speakers or headphones; a video screen and/or a connection port for connecting an external video screen, indicator lights, or the like, together with supporting electronics (e.g., digital-to-analog or analog-to-digital converters, signal processors or the like). These components can be coupled to receive audio and/or video signals via PCD I/O interface 236. Such components can allow the user to view and/or hear output from accessory 230.

Power manager 246 can provide power management capability for accessory 230. For example, power manager 246 can be configured to receive power from a power supply 248. In some embodiments, power supply 248 can include a connection to an external power source (e.g., the standard electric grid); for example, power supply 248 can include an AC-DC converter that can be internal or external to accessory 230. In other embodiments, power supply 248 can include a battery or other energy storage device. Power manager 246 can deliver power from power supply 248 to various components of accessory 230. In addition, in some embodiments, power manager 246 can deliver power to upstream accessories via PCD I/O interface 236.

PCD I/O interface 236 can allow accessory 230 to communicate with portable computing device 250, either directly or through an intermediary. In accordance with some embodiments of the invention, PCD I/O interface 236 can incorporate a USB interface. For example, PCD I/O interface 236 can provide a standard, mini, or micro USB port. In other embodiments, PCD I/O interface 236 can include a connector that can mate directly with a connector included in a portable computing device, such as a 30-pin connector that mates with the connector used on various iPod® products. Such a connector can be used to supply power to or receive power from portable computing device 250, to receive audio and/or video signals in analog and/or digital formats, and to communicate information via various interfaces such as USB, UART, and/or FireWire.

Accessory 230 can be any electronic apparatus that interacts with portable computing device 250. In some embodiments, accessory 230 can provide remote control over operations of portable computing device 250, or a remote user interface that can include both input and output controls (e.g., a display screen). Accessory 230 can control various functions of portable computing device 250 and can also receive media content from portable computing device 250 and present such content to the user (e.g., through audio speakers and/or video display screen, depending on the type of media content). In other embodiments, portable computing device 250 can control operations of accessory 230, such as retrieving stored data from a storage medium of accessory 230, initiating an image capture operation by a camera incorporated into accessory 230, etc. As noted above, communication between accessory 230 and portable computing device 250 can be direct or through an intermediary source, and the presence or absence of an intermediary can be transparent to accessory 230.

It will be appreciated that the system configurations and components described herein are illustrative and that variations and modifications are possible. The portable computing devices and accessories may have other capabilities not specifically described herein. For example, they may incorporate mobile phone, global positioning system (GPS), broadband data communication, Internet connectivity, and the like.

Connectors at the various interfaces can be complementary, or not, as desired. Where two connectors are not complementary, an adapter can be provided to connect the two devices. While connectors may be described herein as having pins, a term generally associated with conventional electronic devices having wires to connect components, it is to be understood that other signal paths (e.g., optical signaling) can be substituted. Further, in some embodiments, some of the connections can be wireless, and connectors can be omitted where wireless interfaces are provided.

Further, while the portable computing device and accessories are described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

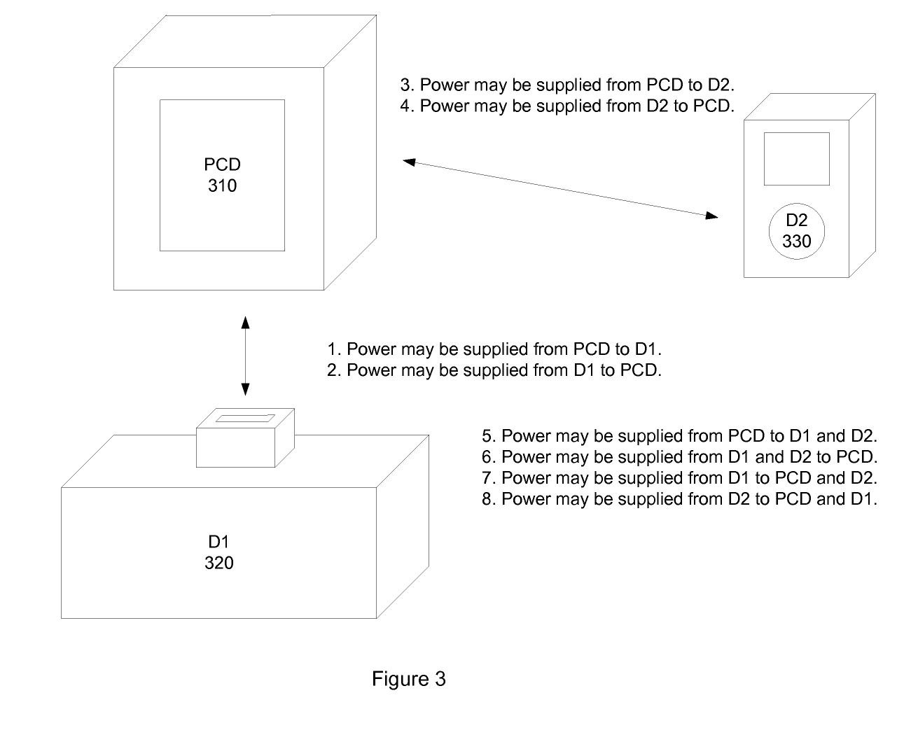

FIG. 3 illustrates an electronic system according to an embodiment of the present invention. This system includes portable computing device 310 and peripheral devices D1 320 and D2 330. One or both of the peripheral devices may connect to portable computing device 310 at connectors such as connector receptacles 155 and 160 shown in FIG. 1. In this example, peripheral device D1 320 will be referred to as a docking station, while peripheral device D2 330 will be referred to as a portable media player. These examples are illustrative and do not limit either the possible embodiments of the present invention or the claims.

In various embodiments of the present invention, one or both of the connectors of portable computing device 310 may have the capability of providing power to or receiving power from a peripheral device. Accordingly, power may be supplied from the portable computing device 310 to docking station 320, or docking station 320 may provide power to portable computing device 310.

Similarly, in various embodiments of the present invention, power may be supplied from portable computing device 310 to portable media player 330, and portable media player 330 may provide power to portable computing device 310.

In various embodiments of the present invention, power may be supplied from portable computing device 310 to both peripheral devices. Specifically, portable computing device 310 may provide power to both portable media player 330 and docking station 320. Similarly, in various embodiments of the present invention, power may be supplied from both external devices to portable computer device 310. Specifically, docking station 320 and portable media player 330 may provide power to portable computing device 310. In other embodiments of the present invention, docking station 320 may provide power to both portable computing device 310 and portable media player 330, or portable media player 330 may provide power to both portable computing device 310 and docking station 320. Various embodiments of the present invention may support any or all of these or other modes of operation.

Again, in various embodiments of the present invention, each connector may have the capability to provide or receive power. An example of how this is done is shown in the following figure.

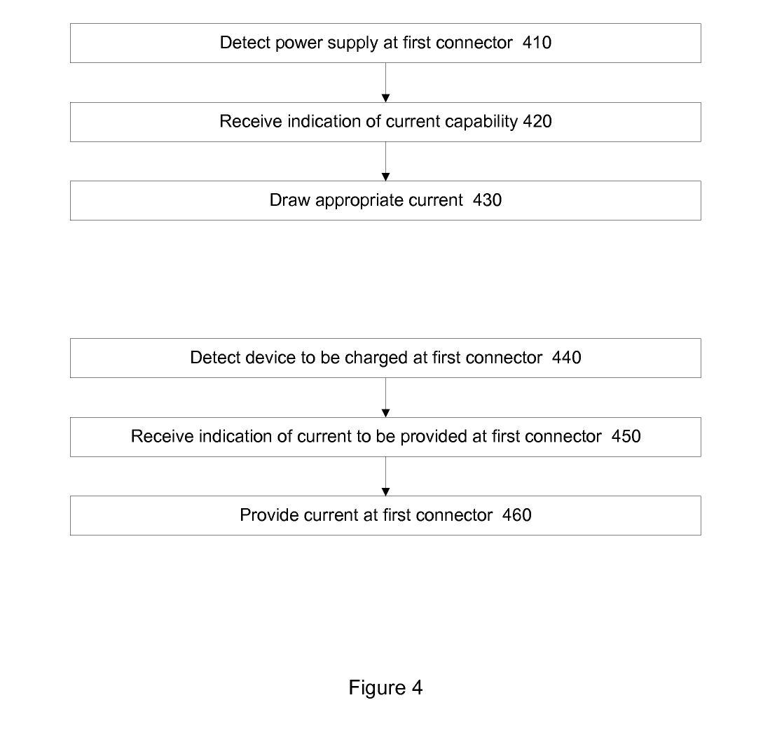

FIG. 4 is a flowchart illustrating the power supply and receiving capabilities of a connector of a portable computing device according to an embodiment of the present invention. In act 410, a power supply may be detected at a first connector. In act 420, an indication of its current capabilities may be received. This indication may be provided by voltage at pins of the connector. In a specific embodiment of the present invention, voltages at USB data pins can indicate a current capability of an external power supply. In other examples, an identification resistor located between two pins of a connector on a peripheral device may indicate the peripheral device's current capacity. In act 430, the appropriate current is drawn at the connector of the portable computing device.

In act 440, a device to be charged may be detected at a first connector. An indication of the current to be provided may be received in act 450. This indication may be a command, an identification resistor, or other means. In act 460, appropriate current may be provided at the first connector.

Again, in various embodiments of the present invention, two or more external devices may provide power to a portable computing device. This is particularly useful when a portable computing device is connected to a docking station at a first connector, and an external charger connected to a second connector is used to supplement charging current. An example of this is shown in the following figure.

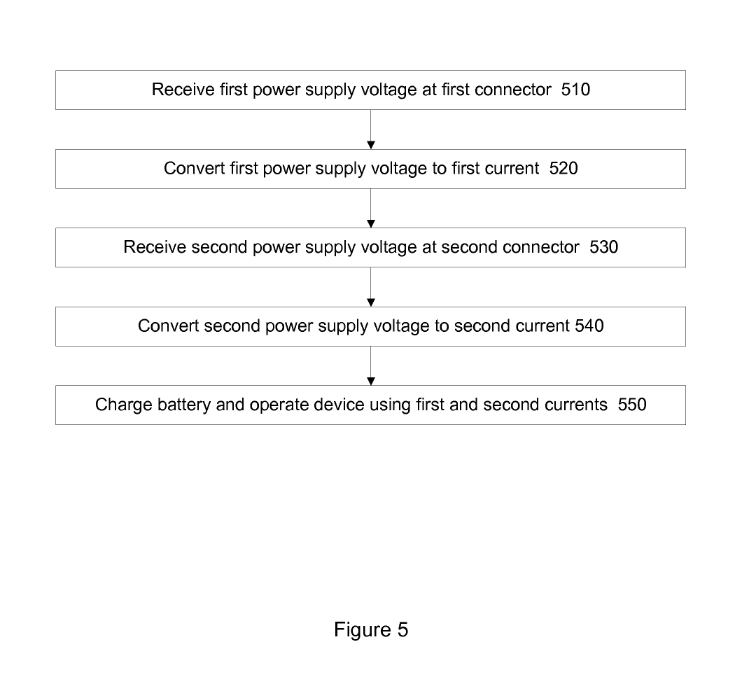

FIG. 5 is a flowchart illustrating a method of receiving power at multiple connectors of a portable computing device according to an embodiment of the present invention. In act 510, a first power supply voltage may be received at a first connector. In act 520, the first power supply voltage may be converted to a first current. In act 530, a second power supply voltage may be received at a second connector. The second power supply voltage may be converted to a second current in act 540. In act 550, a battery may be charged and a portable computing device is operated using the combined first and second currents.

Again, various types of signals may be received and transmitted at the connectors of a portable computing device. One such signal is a universal serial bus (USB) signal. An example is shown in the following figure.

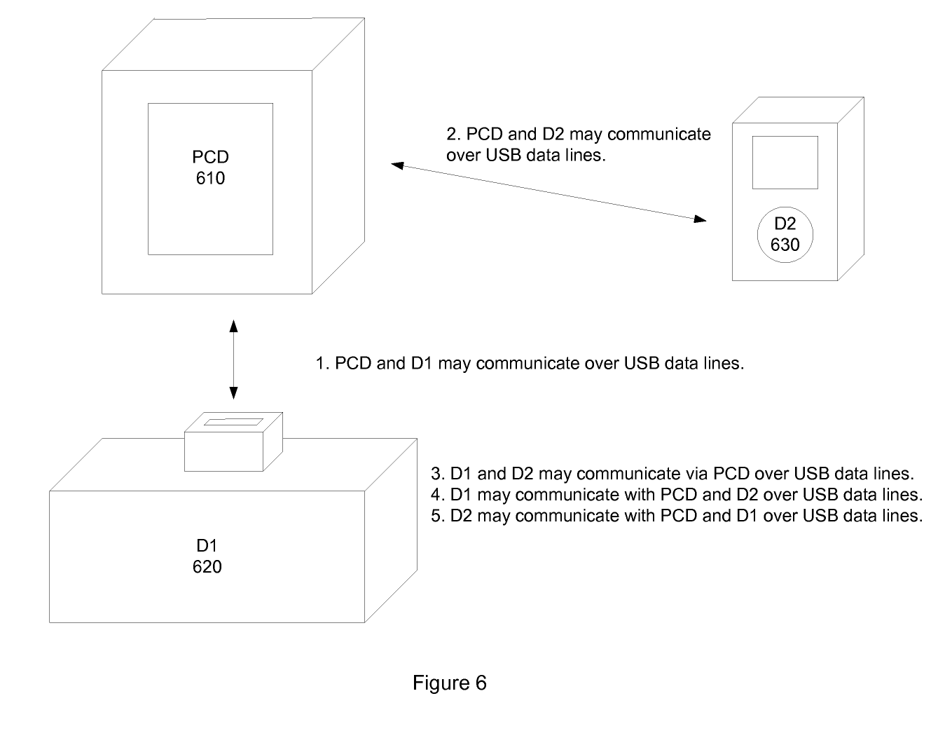

FIG. 6 illustrates an electronic system according to an embodiment of the present invention. As before, portable computing device 610 is in communication with external devices D1 620 and D2 630. In this example, D1 620 will be referred to as a docking station, while device D2 630 will be referred to as a portable media player, though these references, as with references in other figures, are for illustrative purposes only, and do not limit either the possible embodiments of the present invention or the claims.

In various embodiments of the present invention, portable computing device 610 may communicate over USB lines with docking station 620 using a first connector. Similarly, portable computing device 610 and portable media player 630 may communicate over USB data lines using a second connector. Also, in various embodiments of the present invention, docking station 620 may communicate through portable computing device 610 with the portable media player 630. In various embodiments of the present invention, docking station 620 may communicate with both portable computing device 610 and portable media player 630, and portable media device 630 may communicate with portable computing device 510 and docking station 520. Various embodiments of the present invention may support any or all of these or other modes of operation. These USB signals may be compliant with USB1, USB2, USB3, or other USB standards that have been developed, are currently being developed, or will be developed in the future.

In various embodiments of the present invention, it is desirable to provide USB circuitry that is shared between two or more connectors. With this configuration, it may be necessary to decide which peripheral device among multiple peripheral devices the portable computing device 610 should communicate with. An example of one method of resolving this conflict is shown in the following figure.

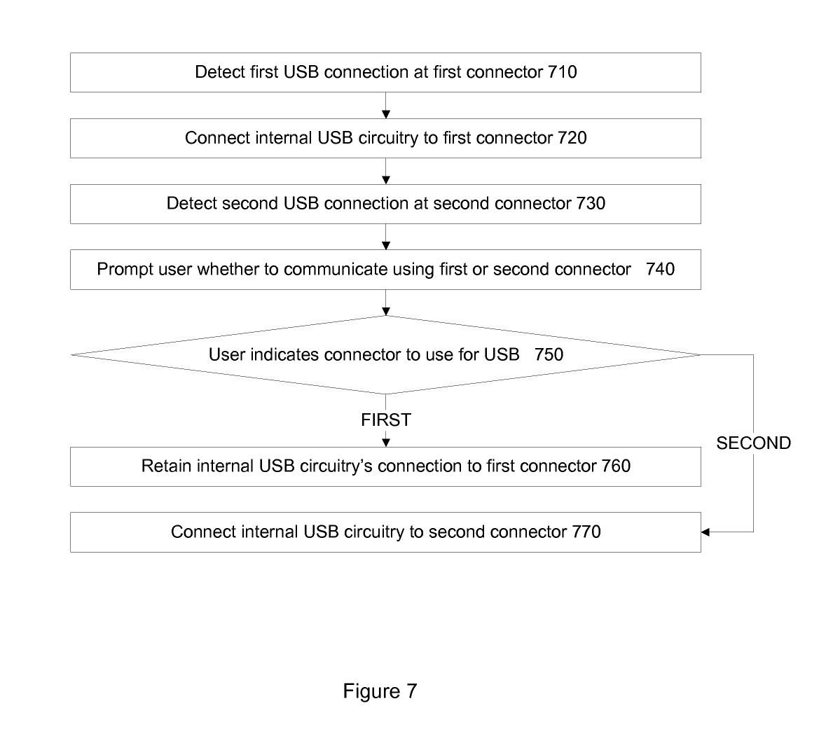

FIG. 7 illustrates a method of resolving a conflict over shared USB circuitry at multiple connectors of a portable computing device according to an embodiment of the present invention. In act 710, a first USB connection is detected at a first connector. In act 720, internal USB circuitry may be connected to the first connector. In act 730, a conflicting second USB connection may be detected at a second connector. Accordingly, a user may be prompted whether to communicate using the first or second connector in act 740. In act 750, the user indicates a preference. If the first connector is indicated, the internal USB circuitry may remain connected to the first connector in act 760. If the preference is for the second connector, the internal USB circuitry may be connected to the second connector in act 770.

With the USB and other circuitry described herein, circuits may be multiplexed among the multiple connectors of a portable computing device. In other embodiments of the present invention, multiple buffers may be used, each buffer connected to a connector. Individual buffers may be enabled and disabled as the connectors become active and inactive.

In various embodiments of the present invention, other algorithms may be used to determine which connector the internal USB circuitry is connected to. For example, the first detected USB connection may retain the internal circuitry until the connection is broken. In other embodiments of the present invention, the internal USB circuitry is connected to the most recently formed USB connection. Once a decision is made as to where to connect the internal USB circuitry, further decisions are made when a connection is removed. An example is shown in the following figure.

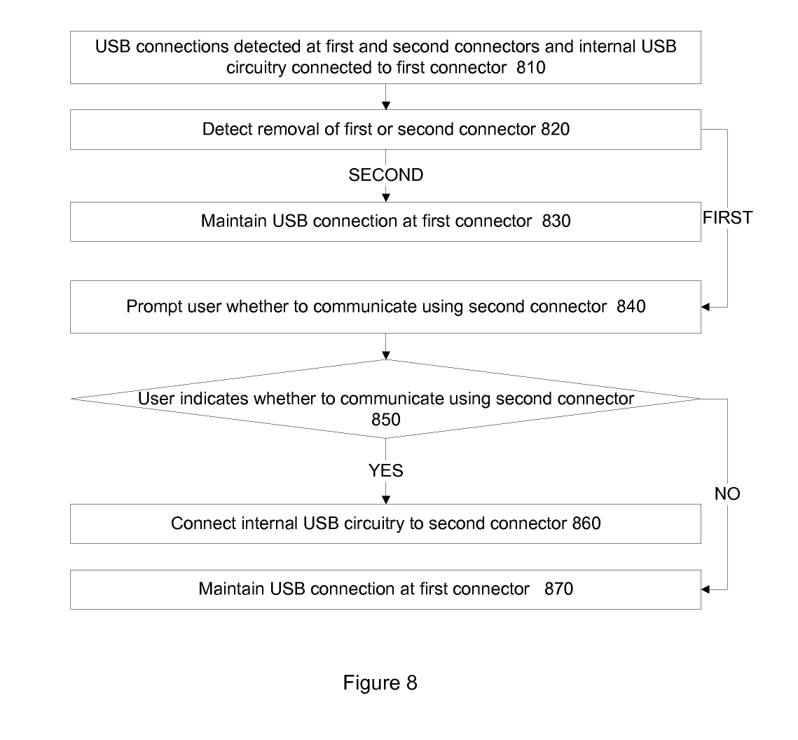

FIG. 8 illustrates a method of resolving conflicts at multiple connectors of a portable computing device when one or more connections are removed. In act 810, USB connections have been detected at first and second connectors and internal USB circuitry has been connected to the first connector. In act 820, the removal of a connection may be detected. If the second connection has been broken, the USB connection of the first connector is maintained in act 830. If the first USB connection at the first connector is broken, there exists a possibility that the connection has been broken accidentally. For this reason, the user may be prompted as to whether communication should begin using the second connector in act 840. In act 850, the user indicates a preference. If the response is yes, the internal USB circuitry may be connected to the second connector in act 860. If the answer is no, USB circuitry connection in the first connector may be maintained in act 870.

Again, other methods of resolving this conflict may be utilized. For example, once a connection is broken, internal USB circuitry may be connected to the connector having the remaining connection.

Other types of signals that may be shared at connectors of a portable computing device include video signals. These video signals may be analog or digital signals. An example is shown in the following figures.

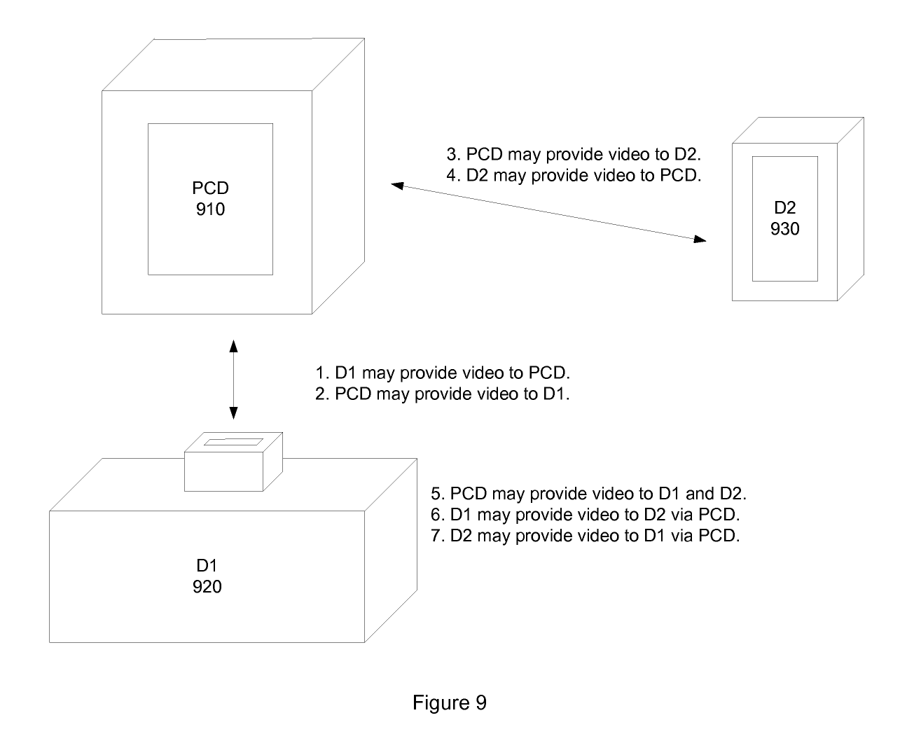

FIG. 9 illustrates an electronic system according to an embodiment of the present invention. This electronic system includes portable computing device 910 and peripheral devices D1 920 and D2 930. In this example, device D1 920 will be referred to as a docking station, while device D2 930 will be referred to as a monitor. As before, these examples are illustrative and do not limit either the possible embodiments of the present invention or the claims.

In various embodiments of the present invention, video signals may be supplied or provided at the connectors of the portable computing device 910. Accordingly, in various embodiments of the present invention, docking station 920 may provide video to portable computing device 910, and portable computing device 910 may provide video to docking station 920. Similarly, portable computing device 910 may provide video to monitor 930, while monitor 930 may provide video to portable computing device 910. In various embodiments of the present invention, portable computing device 910 may provide video to both docking station 920 and monitor 930. Also, in some embodiments of the present invention, docking station 920 may provide video to monitor 930 via portable computing device 910, while monitor 930 may provide video to docking station 920 via portable computing device 910. Various embodiments of the present invention may support any or all of these or other modes of operation. Analog video signals may be compliant with one or more other video standards, such as one or more of the family of VGA standards. Digital video signals may be compliant with one or more standards such as DVI, HDMI, or DisplayPort. Various embodiments of the present invention may supply or receive analog, digital, or both analog and digital video signals that are compliant with standards that have been developed, are currently being developed, or will be developed in the future.

As with the USB circuitry, various embodiments of the present invention provide portable computing devices having video circuitry that is shared among multiple connectors. Again, this may cause conflicts if multiple video compatible devices are simultaneously connected to the portable computing device. An example of how this conflict may be resolved is shown in the following figure.

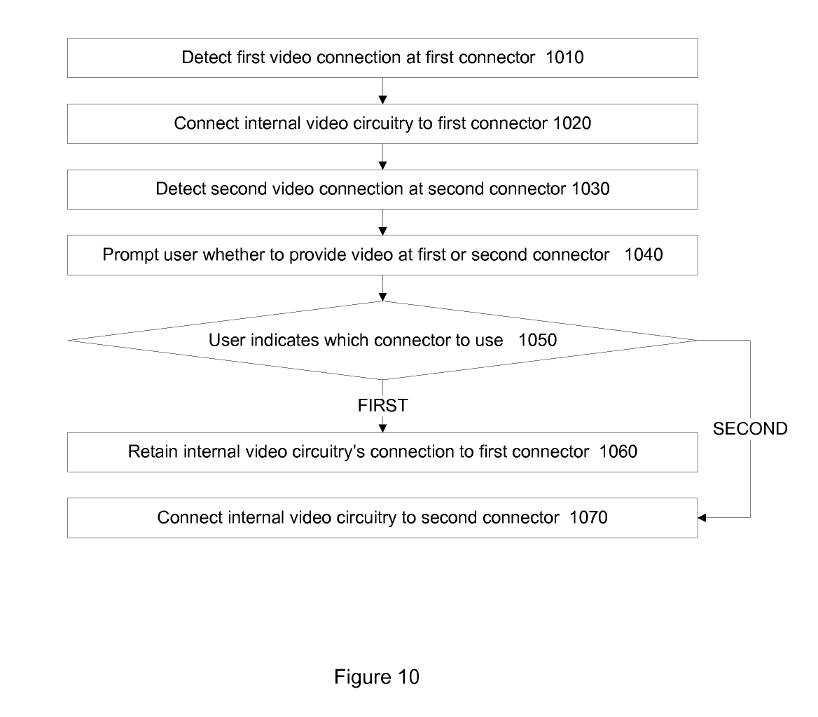

FIG. 10 illustrates a method of resolving a conflict for video circuitry shared between multiple connectors of a portable computing device according to an embodiment of the present invention. In act 1010, a first video connection may be detected at a first connector. In act 1020, internal video circuitry is connected to the first connector. A second video connection may be detected at the second connector in act 1030. In act 1040, the user may be prompted whether to connect the video circuitry to the first or second connector. In act 1050, the user may indicate a preference. If the first connector is indicated as preferred, the internal video connection may be maintained with the first connector in act 1060. If the second connector is indicated, the internal video circuitry may be connected to the second connector in act 1070.

As before, there are other ways of resolving this conflict consistent with embodiments of the present invention. For example, the video connection may be maintained with the first connection. In other embodiments of the present invention, a video connection may be made with a most recently formed connection. Once a connection is determined, again, a decision may need to be made when one of the multiple connections is broken. An example of this is shown in the following figure.

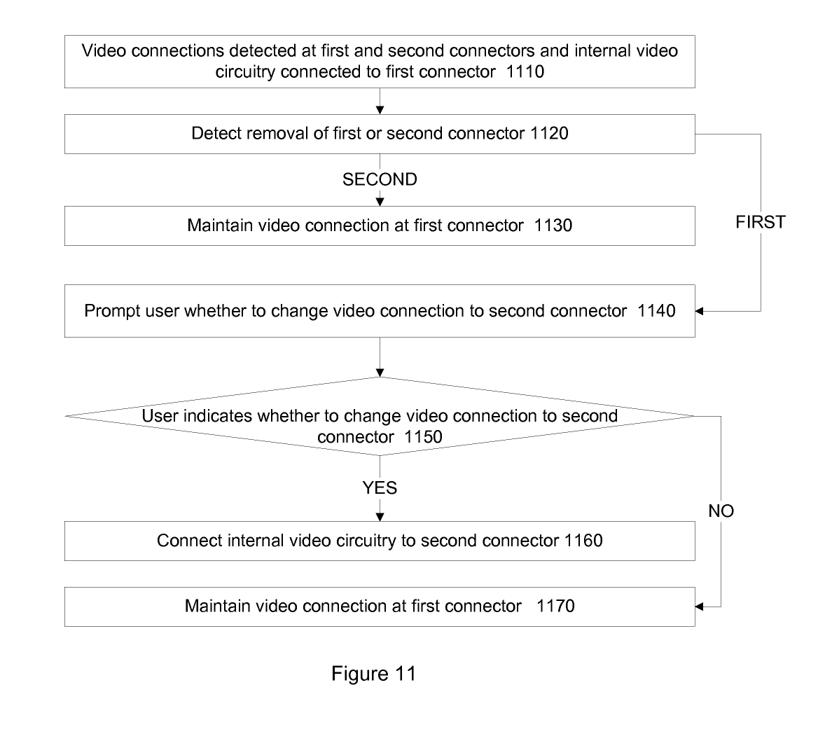

FIG. 11 illustrates a method of resolving a conflict at multiple connectors when a connection at one of the connectors is broken. In act 1110, video connections have been detected at first and second connectors and the internal video circuitry is connected to the first connector. In act 1120, the removal of one of the connections may be detected. If the second connection is broken, the video connection may be maintained at the first connector in act 1130. If the first video connection has been broken, there is a chance that the disconnection has been accidental. Accordingly, the user may be prompted whether to change the video connection to the second connector in act 1140. If the user indicates the answer is yes in act 1150, the internal video circuitry may be connected to the second connector in act 1160. If the response is no, the video connection may be maintained at the first video connector in act 1170.

Again, other methods of resolving this conflict may be utilized. For example, once a connection is broken, internal video circuitry may be connected to the connector having the remaining connection.

Other types of signals that may be shared at connectors of a portable computing device include audio signals. These audio signals may be analog or digital signals. An example is shown in the following figures.

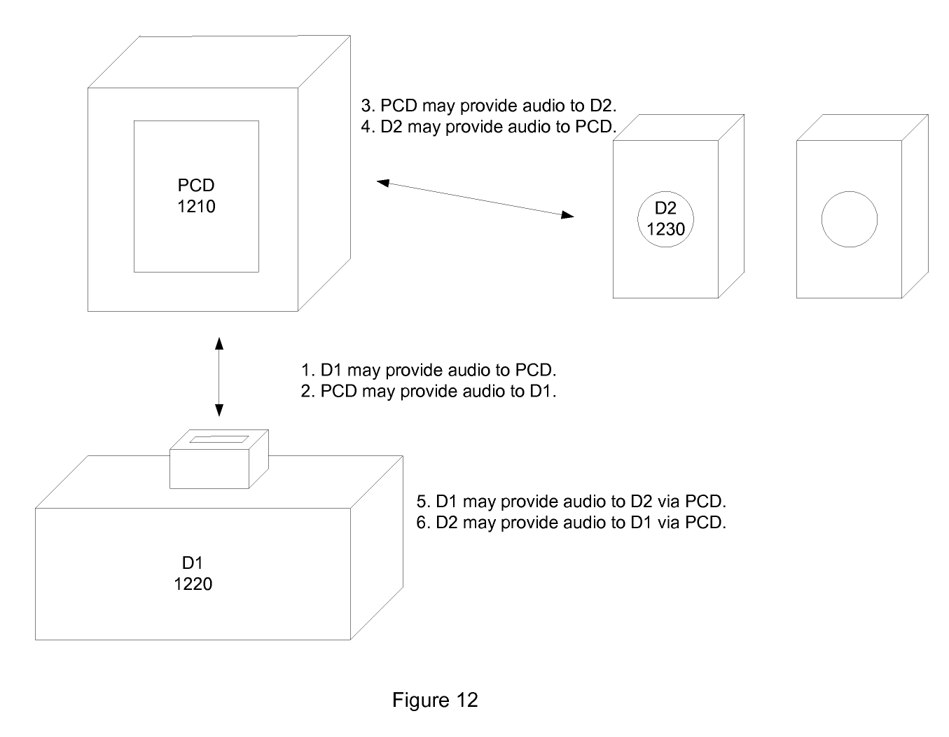

FIG. 12 illustrates an electronic system according to an embodiment of the present invention. This electronic system includes portable computing device 1210 and peripheral devices D1 1220 and D2 1230. In this example, device D1 1220 will be referred to as a docking station, while device D2 1230 will be referred to as a speaker system. As before, these examples are illustrative and do not limit either the possible embodiments of the present invention or the claims.

In various embodiments of the present invention, audio signals may be supplied or provided at the connectors of the portable computing device 1210. Accordingly, in various embodiments of the present invention, docking station 1220 may provide audio to portable computing device 1210, and portable computing device 1210 may provide audio to docking station 1220. Similarly, portable computing device 1210 may provide audio to speaker system 1230, while speaker system 1230 may provide audio to portable computing device 1210. In some embodiments of the present invention, docking station 1220 may provide audio to speaker system 1230 via portable computing device 1210, while speaker system 1230 may provide audio to docking station 1220 via portable computing device 1210. Various embodiments of the present invention may support any or all of these or other modes of operation. Analog audio signals may be compliant with one or more audio standards. Digital audio signals may be compliant with one or more standards such as MP3, WMA, WAV, or MIDI. Various embodiments of the present invention may supply or receive analog, digital, or both analog and digital audio signals that are compliant with standards that have been developed, are currently being developed, or will be developed in the future.

As with the USB and video circuitry, various embodiments of the present invention provide portable computing devices having audio circuitry that is shared among multiple connectors. Again, this may cause conflicts if multiple audio compatible devices are simultaneously connected to the portable computing device. In some of these embodiments, a ground sense line is taken from among multiple connectors as well. Having a quiet ground return line improves audio signal quality. In a specific embodiment of the present invention, a ground at the connector is used as a ground sense line. The ground sense line for the active connector is fed back to the internal audio circuitry to reduce noise. An example of how this conflict may be resolved is shown in the following figure.

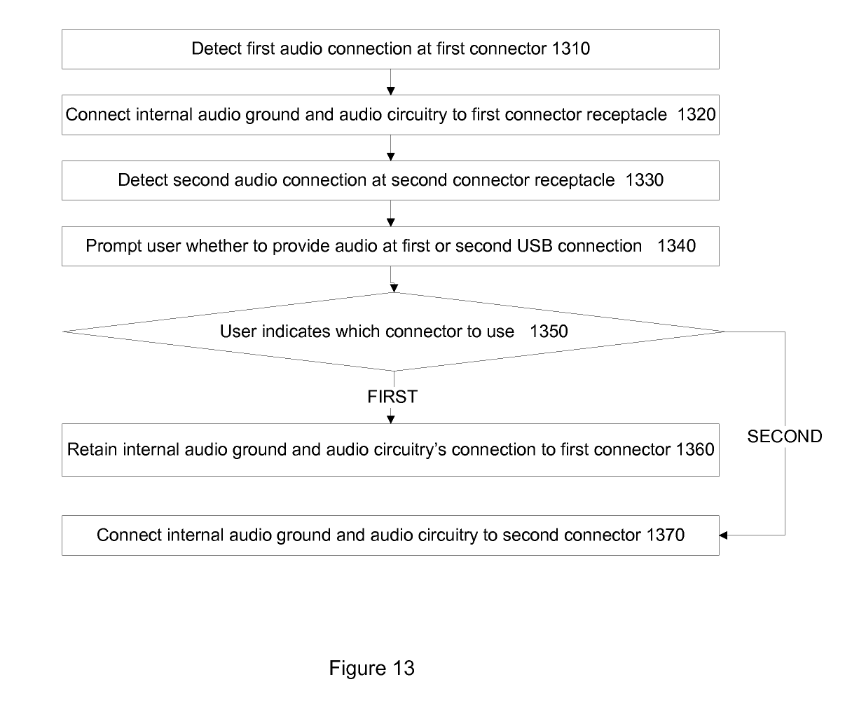

FIG. 13 illustrates a method of resolving a conflict for audio circuitry shared between multiple connectors of a portable computing device according to an embodiment of the present invention. In act 1310, a first audio connection may be detected at a first connector. In act 1320, an internal ground and audio circuitry may be connected to the first connector. A second audio connection may be detected at the second connector in act 1330. In act 1340, the user may be prompted whether to connect the ground and audio circuitry to the first or second connector. In act 1350, the user may indicate a preference. If the first connector is indicated as preferred, the internal ground and audio connection may be maintained with the first connector in act 1360. If the second connector is indicated, the internal ground and audio circuitry may be connected to the second connector in act 1370.

As before, there are other ways of resolving this conflict consistent with embodiments of the present invention. For example, the audio connection may be maintained with the first connection. In other embodiments of the present invention, an audio connection may be made with a most recently formed connection. Once a connection is determined, again, a decision may need to be made when one of the multiple connections is broken. An example of this is shown in the following figure.

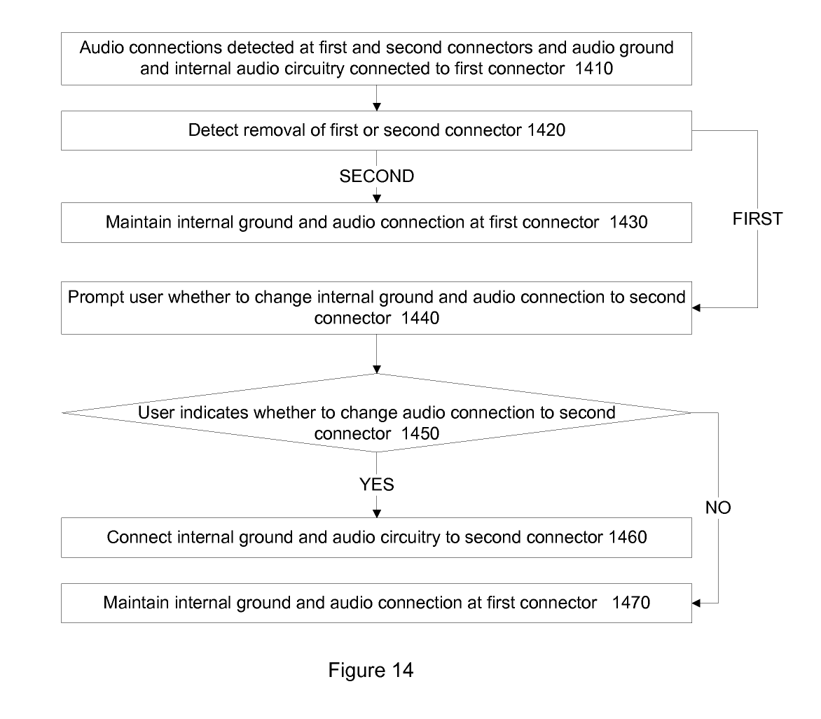

FIG. 14 illustrates a method of resolving a conflict at multiple connectors when a connection at one of the connectors is broken. In act 1410, audio connections have been detected at first and second connectors and the internal ground and audio circuitry is connected to the first connector. In act 1420, the removal of one of the connections may be detected. If the second connection is broken, the audio connection may be maintained at the first connector in act 1430. If the first audio connection has been broken, there is a chance that the disconnection has been accidental. Accordingly, the user may be prompted whether to change audio connection to the second connector in act 1440. If the user indicates the answer is yes in act 1450, the internal ground and audio circuitry may be connected to the second connector in act 1460. If the response is no, the audio connection may be maintained at the first audio connector in act 1470.

Again, other methods of resolving this conflict may be utilized. For example, once a connection is broken, the internal ground and audio circuitry may be connected to the connector having the remaining connection.

Again, various types of signals may be received and transmitted at the connectors of a portable computing device. One such signal is a serial bus signal. An example is shown in the following figure.

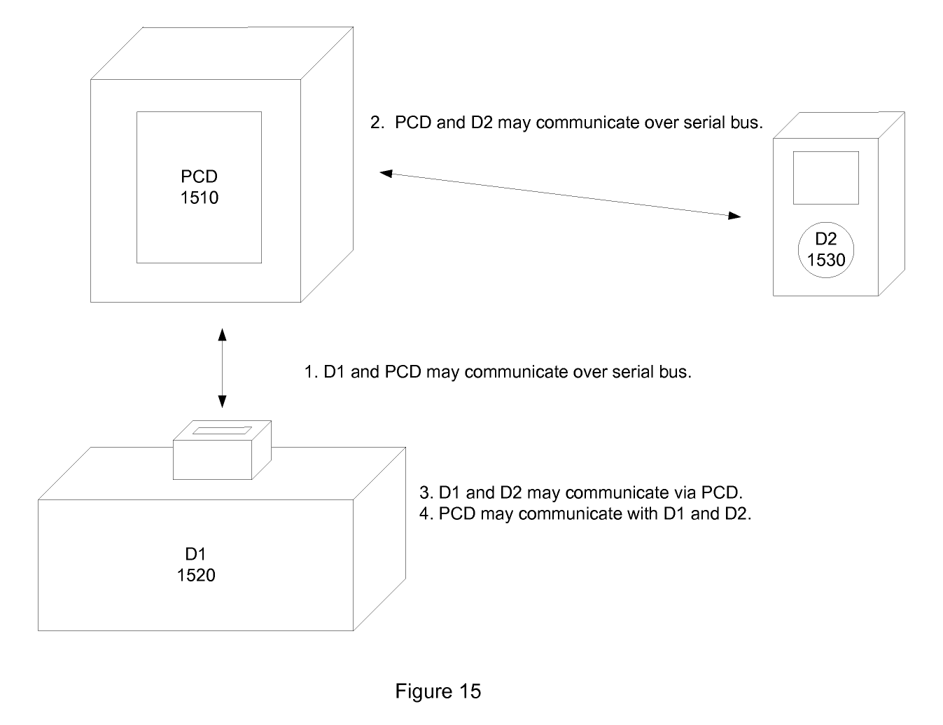

FIG. 15 illustrates an electronic system according to an embodiment of the present invention. This electronic system includes portable computing device 1510 and peripheral devices D1 1520 and D2 1530. In this example, device D1 1520 will be referred to as a docking station, while device D2 1530 will be referred to as a monitor. As before, these examples are illustrative and do not limit either the possible embodiments of the present invention or the claims.

In various embodiments of the present invention, portable computing device 1510 may communicate with docking station 1520, while portable computing device 1510 may communicate with portable media player 1530. In various embodiments of the present invention, docking station 1520 may communicate with portable media player 1530 via portable computing device 1510. In various embodiments of the present invention, portable computing device 1510 may communicate with both docking station 1520 and portable media player 1530. Various embodiments of the present invention may support any or all of these or other modes of operation.

These serial signals may be compliant with standards that have been developed, are currently being developed, or will be developed in the future. Often, these communications are performed using a universal asynchronous receiver/transmitter (UART.) This circuitry is typically included at each connector, such that as new connections are made, the portable computing device may determine if conflicts, such as those described above, exist.

Having a UART at each connector provides several advantages. For example, when multiple devices are connected, internal software can determine if a conflict exists. To the extent that a conflict arises, a user can be prompted for a resolution. To the extent that software can determine that a conflict does not exist, unnecessary inquiries to the user can be avoided.

For example, if a portable computing device is connected to a docking station at a first connector, and a power supply is received at a second connector, no conflict exits and the user does not need to be prompted. But if a conflicting device, for example, a second USB device, is connected, the user can be prompted to resolve the conflict.

In some embodiments of the present invention, for the purposes of acting in a consistent manner, some unnecessary prompts may be desirable. For example, a user may expect a prompt when a second device is connected because the user received a prompt when a similar, but different second device was connected. To not provide a prompt in this case may cause user confusion.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A method of charging a battery housed in a portable computing device, the method comprising:
receiving a first power supply voltage at a first connector;
converting the first received power supply voltage to a first current;
receiving a second power supply voltage at a second connector;
converting the second received power supply voltage to a second current;
combining the first current and the second current; and
charging a battery using the combined first and second currents.

2. The method of claim 1 wherein the first power supply voltage is a supply voltage for a universal serial bus.

3. The method of claim 1 wherein the first power supply voltage is a supply voltage for a universal serial bus and the second power supply voltage is a supply voltage for a universal serial bus.

4. The method of claim 1 wherein the first power supply voltage is provided by a docking station accessory.

5. The method of claim 4 wherein the second power supply voltage is provided by a charger.

6. A method of communicating using a first and a second connector, the method comprising:
detecting a first communication connection at the first connector;
connecting internal communication circuitry to the first connector;
detecting a second communication connection at the second connector;
providing a prompt inquiring whether to use the first connector or the second connector; and
if the response is the first connector, then maintaining the internal communication circuitry connection to the first connector; else
connecting the internal communication circuitry to the second connector.

7. The method of claim 6 further comprising:
if the response is the first connector, detecting removal of the second connector; and
maintaining the internal communication circuitry connection to the first connector.

8. The method of claim 6 further comprising:
if the response is the first connector, detecting removal of the first connector;
providing a prompt inquiring whether to use the second connector; and
if the response is no, then maintaining the internal communication circuitry connection to the first connector; else
connecting the internal communication circuitry to the second connector.

9. The method of claim 6 wherein the first communication connection is a universal serial bus connection.

10. The method of claim 6 wherein the first communication connection is a video connection.

11. The method of claim 6 wherein the first communication connection is a audio connection.

12. The method of claim 6 wherein the prompt is provided to a user on a touch screen.

13. A method of communicating using a first and a second connector, the method comprising:
detecting a first audio connection at the first connector;
connecting an internal ground and audio circuitry to the first connector;
detecting a second audio connection at the second connector;
providing a prompt inquiring whether to use the first connector or the second connector; and
if the response is the first connector, then maintaining the internal ground and audio circuitry connection to the first connector; else
connecting the internal ground and audio circuitry to the second connector.

14. The method of claim 13 further comprising:
if the response is the first connector, detecting removal of the second connector; and
maintaining the internal ground and audio circuitry connection to the first connector.

15. The method of claim 13 further comprising:
if the response is the first connector, detecting removal of the first connector;
providing a prompt inquiring whether to use the second connector; and
if the response is no, then maintaining the internal ground and audio circuitry connection to the first connector; else
connecting the internal ground and audio circuitry to the second connector.

16. The method of claim 13 wherein the prompt is provided to a user on a touch screen.

17. A method of communicating with a first accessory and a second accessory comprising:
communicating with a first accessory using a first connector;
authenticating the first accessory;
determining a classification for the first accessory;
communicating with a second accessory using a second connector;
authenticating the second accessory; and
determining a classification for the second accessory.

18. The method of claim 17 further comprising:
providing data to the first accessory and the second accessory based in part on the classification of the first accessory and the classification of the second accessory.

19. The method of claim 17 where the first accessory is a docking station.

20. The method of claim 17 wherein communication with the first accessory is performed using a universal asynchronous receiver/transmitter.
